(19) United States
(12) Patent Application Publication
(10) Pub. No.: US 2003/0196943 A1
(43) Pub. Date: Oct. 23, 2003

(54) Go Filter

(76) Inventors: Joseph F. Falce, Plainedge, NY (US); Frank J. Augello, Bronx, NY (US)

Correspondence Address: JOSEPH F. FALCE, 71 Wadsworth Ave., Plainedge, NY, 11756, US

(21) Appl. No.: 10/127,813

(22) Filed: Apr. 23, 2002

(51) Int. Cl. B01D 35/02

(52) U.S. Cl. 210/171; 210/181; 210/443

(57) ABSTRACT

The automotive coolant filter was devised as a result of the inventor servicing an automotive cooling system and witnessing the evidence of contaminants depositing on cooling system surfaces. The inventor reasoned that other vital engine fluids such as motor oil and transmission fluid are filtered, wouldn't the coolant benefit also from filtration? Of course! By the simple filtration of circulating engine coolant through a paper or a fiber corrugated element, the majority of transient contaminants will be trapped. This in turn will extend the life of anti-freeze coolant as well as vital engine cooling system components.

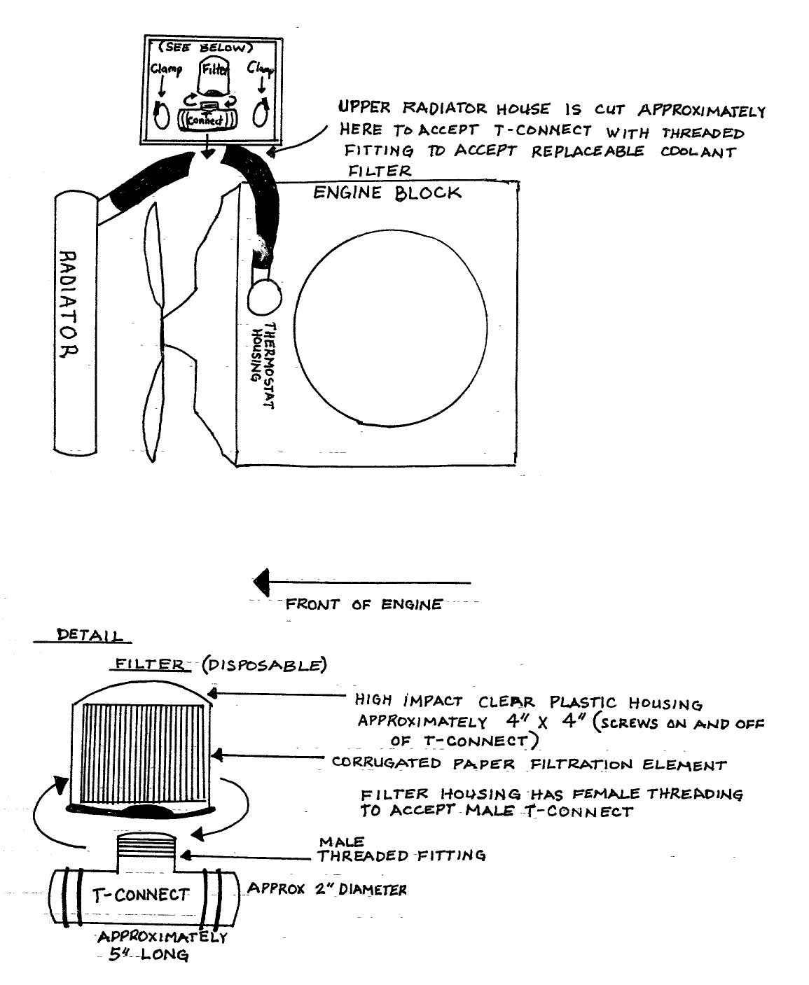

### SUMMARY OF THE INVENTION

The automotive coolant filter was devised as a result of the inventor servicing an automotive cooling system and witnessing the evidence of contaminants depositing on cooling system surfaces. The inventor reasoned that other vital engine fluids such as motor oil and transmission fluid are filtered, wouldn't the coolant benefit also from filtration? Of course! By the simple filtration of circulating engine coolant through a paper or a fiber corrugated element, the majority of transient contaminants will be trapped. This in turn will extend the life of anti-freeze coolant as well as vital engine cooling system components.

### BACKGROUND OF INVENTION

To be used in the used effective manner prolonging life and efficiency of automotive water cooled engine. But not limited to such; may be adapted to aircraft, agricultural and industrial machinery.

What I claim as my invention is:

1. I. A device to effectively remove transient contaminants in your automotive coolant which lead to reduced efficiency of your cooling system including radiator, heater core, cylinder heads and water pump
II. By capturing rust, scale and other contaminants, the water jackets in your engine block and heads, along with radiator cross flow tubes will remain unobstructed longer. This will increase the life of your engine. A cooler, cleaner engine operates more effectively. This increases mileage and performance.
